(19) United States
(12) Patent Application Publication
(10) Pub. No.: US 2014/0188731 A1
(43) Pub. Date: Jul. 3, 2014

(54) SIGN IN BASED ON RECOGNITION INSTEAD OF PASSWORD

(71) Applicant: Wal-Mart Stores, Inc., Bentonville, AR (US)

(72) Inventor: David Patterson, Berkeley, CA (US)

(73) Assignee: Wal-Mart Stores, Inc., Bentonville, AR (US)

(21) Appl. No.: 13/730,615

(22) Filed: Dec. 28, 2012

(51) Int. Cl. G06Q 99/00

(52) U.S. Cl. CPC G06Q 99/00
USPC 705/50

(57) ABSTRACT

The present disclosure extends to methods, systems, and computer program products for providing a customer access to a merchant's secure network. In operation, the customer may be presented with recognizable tokens and non-recognizable decoy tokens for selection instead of entering a password.

### BACKGROUND

The username/password method for sign in to a web site in current computer and web environments is cumbersome and archaic because of too many points of access with each having a password and log in to remember. Accordingly a customer often either uses the same one or two passwords for the differing points of access, or a customer writes them down in a convenient place lest they forget them. Either way, passwords are easily forgotten and/or easily stolen, especially if written down.

These problems apply even with the use of a single sign on via access point such as Google.com™ and FaceBook Connect™, or other similar services and programs. The disclosed methods and systems herein, require no memorization and nothing but reflexive recognition. It also provides the benefits of personalization of the access points by the customer.

### BRIEF DESCRIPTION OF THE DRAWINGS

Non-limiting and non-exhaustive implementations of the present disclosure are described with reference to the following figures, wherein like reference numerals refer to like parts throughout the various views unless otherwise specified. Advantages of the present disclosure will become better understood with regard to the following description and accompanying drawings where:

FIG. 1 illustrates an example block diagram of a computing device;

FIG. 2 illustrates an example retail location and computer architecture that facilitates different implementations described herein;

FIG. 3 illustrates a flow chart of an example method according to one implementation;

FIG. 4 illustrates an implementation of a customer interface in accordance with the disclosed methods and systems;

FIG. 5 illustrates an implementation of a customer interface in accordance with disclosed methods and systems;

FIG. 6 illustrates an implementation of a customer interface in accordance with disclosed methods and systems; and

FIG. 7 illustrates a flow chart of an example method according to one implementation.

### DETAILED DESCRIPTION

The present disclosure extends to methods, systems, and computer program products for providing secure access to a customer on a merchant's networks or within a merchant's retail location. In the following description of the present disclosure, reference is made to the accompanying drawings, which form a part hereof, and in which is shown by way of illustration specific implementations in which the disclosure may be practiced. It is understood that other implementations may be utilized and structural changes may be made without departing from the scope of the present disclosure.

Implementations of the present disclosure may comprise or utilize a special purpose or general-purpose computer including computer hardware, such as, for example, one or more processors and system memory, as discussed in greater detail below. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures that can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. RAM can also include solid state drives (SSDs or PCIx based real time memory tiered Storage, such as FusionIO). Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. It should be noted that any of the above mentioned computing devices may be provided by or located within a brick and mortar location. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Implementations of the disclosure can also be used in cloud computing environments. In this description and the following claims, “cloud computing” is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, e.g., on-demand self-service, broad network access, resource pooling, rapid elasticity, measured service, or any suitable characteristic now known to those of ordinary skill in the field, or later discovered), service models (e.g., Software as a Service (SaaS), Platform as a Service (PaaS), Infrastructure as a Service (IaaS), and deployment models (e.g., private cloud, community cloud, public cloud, hybrid cloud, or any suitable service type model now known to those of ordinary skill in the field, or later discovered). Databases and servers described with respect to the present disclosure can be included in a cloud model.

As used herein, the terms “customer” and “user” are used interchangeably, and are intended to denote that a customer can be both accessing a merchant network within a brick and mortar retail location, as well as a customer who is a user on a computing device.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the following description and Claims to refer to particular system components. As one skilled in the art will appreciate, components may be referred to by different names. This document does not intend to distinguish between components that differ in name, but not function.

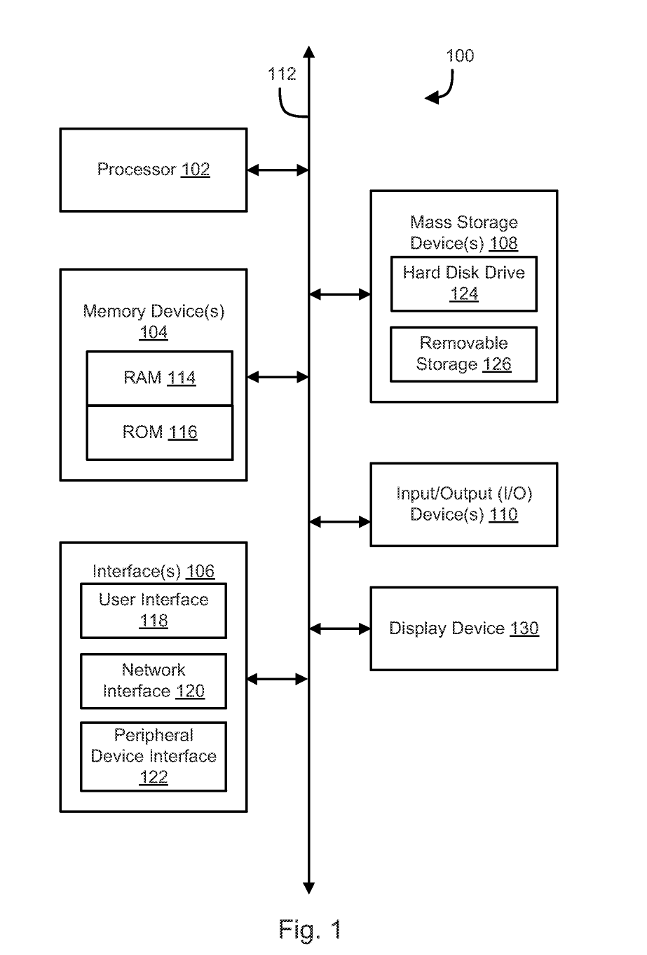

FIG. 1 is a block diagram illustrating an example computing device 100. Computing device 100 may be used to perform various procedures, such as those discussed herein. Computing device 100 can function as a server, a client, or any other computing entity. Computing device can perform various monitoring functions as discussed herein, and can execute one or more application programs, such as the application programs described herein. Computing device 100 can be any of a wide variety of computing devices, such as a desktop computer, a notebook computer, a server computer, a handheld computer, tablet computer and the like.

Computing device 100 includes one or more processor(s) 102, one or more memory device(s) 104, one or more interface(s) 106, one or more mass storage device(s) 108, one or more Input/Output (I/O) device(s) 110, and a display device 130 all of which are coupled to a bus 112. Processor(s) 102 include one or more processors or controllers that execute instructions stored in memory device(s) 104 and/or mass storage device(s) 108. Processor(s) 102 may also include various types of computer-readable media, such as cache memory.

Memory device(s) 104 include various computer-readable media, such as volatile memory (e.g., random access memory (RAM) 114) and/or nonvolatile memory (e.g., read-only memory (ROM) 116). Memory device(s) 104 may also include rewritable ROM, such as Flash memory.

Mass storage device(s) 108 include various computer readable media, such as magnetic tapes, magnetic disks, optical disks, solid-state memory (e.g., Flash memory), and so forth. As shown in FIG. 1, a particular mass storage device is a hard disk drive 124. Various drives may also be included in mass storage device(s) 108 to enable reading from and/or writing to the various computer readable media. Mass storage device(s) 108 include removable media 126 and/or non-removable media.

I/O device(s) 110 include various devices that allow data and/or other information to be input to or retrieved from computing device 100. Example I/O device(s) 110 include cursor control devices, keyboards, keypads, microphones, monitors or other display devices, speakers, printers, network interface cards, modems, lenses, CCDs or other image capture devices, and the like.

Display device 130 includes any type of device capable of displaying information to one or more users of computing device 100. Examples of display device 130 include a monitor, display terminal, video projection device, and the like.

Interface(s) 106 include various interfaces that allow computing device 100 to interact with other systems, devices, or computing environments. Example interface(s) 106 may include any number of different network interfaces 120, such as interfaces to local area networks (LANs), wide area networks (WANs), wireless networks, and the Internet. Other interface(s) include user interface 118 and peripheral device interface 122. The interface(s) 106 may also include one or more user interface elements 118. The interface(s) 106 may also include one or more peripheral interfaces such as interfaces for printers, pointing devices (mice, track pad, etc.), keyboards, and the like.

Bus 112 allows processor(s) 102, memory device(s) 104, interface(s) 106, mass storage device(s) 108, and I/O device(s) 110 to communicate with one another, as well as other devices or components coupled to bus 112. Bus 112 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 100, and are executed by processor(s) 102. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

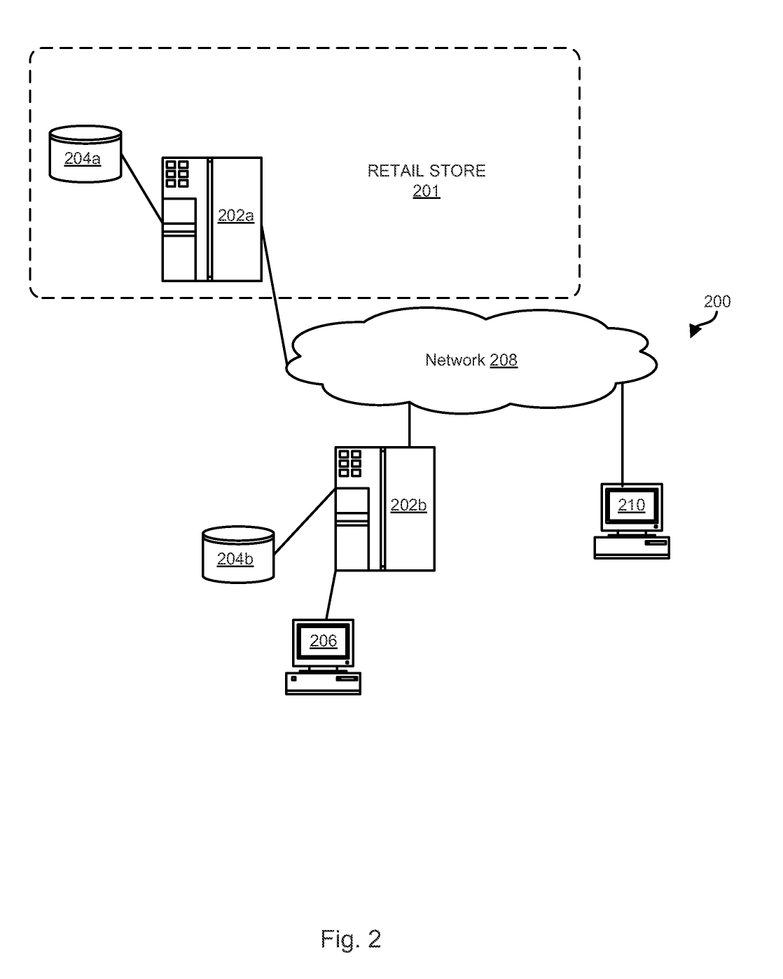

FIG. 2 illustrates an example of a computing environment 200 and a brick and mortar retail location 201 suitable for implementing the methods disclosed herein. In some implementations, a server 202a provides access to a database 204a in data communication therewith, and may be located and accessed within a brick and mortar retail location. The database 204a may store customer attribute information such as a user profile as well as a list of other user profiles of friends and associates associated with the user profile. The database 204a may additionally store attributes of the user associated with the user profile. The server 202a may provide access to the database 204a to users associated with the user profiles and/or to others. For example, the server 202a may implement a web server for receiving requests for data stored in the database 204a and formatting requested information into web pages. The web server may additionally be operable to receive information and store the information in the database 204a.

A server 202b may be associated with a merchant or by another entity or party providing gift recommendation services. The server 202b may be in data communication with a database 204b. The database 204b may store information regarding various products. In particular, information for a product may include a name, description, categorization, reviews, comments, price, past transaction data, and the like. The server 202b may analyze this data as well as data retrieved from the database 204a in order to perform methods as described herein. An operator or customer/user may access the server 202b by means of a workstation 206, which may be embodied as any general purpose computer, tablet computer, smart phone, or the like.

The server 202a and server 202b may communicate with one another over a network 208 such as the Internet or some other local area network (LAN), wide area network (WAN), virtual private network (VPN), or other network. A user may access data and functionality provided by the servers 202a, 202b by means of a workstation 210 in data communication with the network 208. The workstation 210 may be embodied as a general purpose computer, tablet computer, smart phone or the like. For example, the workstation 210 may host a web browser for requesting web pages, displaying web pages, and receiving user interaction with web pages, and performing other functionality of a web browser. The workstation 210, workstation 206, servers 202a-202b, and databases 204a, 204b may have some or all of the attributes of the computing device 100.

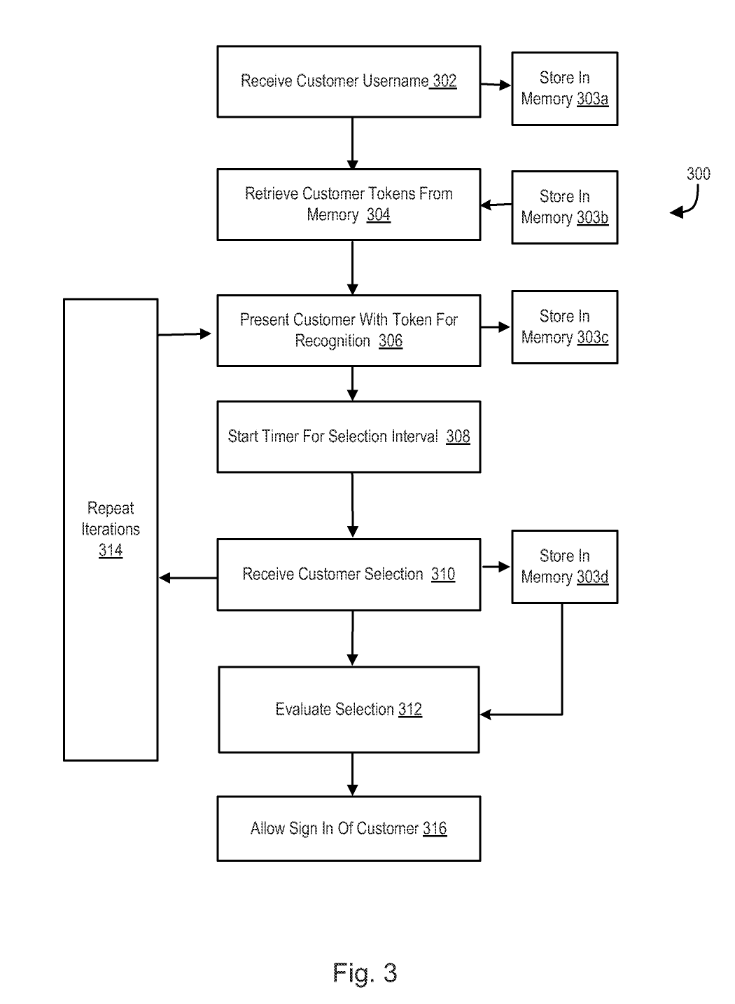

With reference primarily to FIG. 3, an implementation of a method 300 for allowing secure access to a merchant's network through token recognition will be discussed. FIG. 1 and FIG. 2 may be referenced secondarily during the discussion in order to provide hardware support for the implementation. The disclosure aims to disclose methods and systems to allow a customer to designate a plurality of tokens, that when used at a sign in opportunity, can replace the need for the customer to remember a password. A token, as used herein, is intended to mean any computer output that can be recognized sensorially by the customer and then selected by the customer. For example, a token may be a photo that a customer would recognize when shown the photo on a display. In an implementation a token may be sound, or series of sounds that could be presented to a user for selection. In an implementation a token may be a picture or description of a previously purchased item that is displayed to a customer. In an implementation the token may be pulsing visuals or sounds that the customer can recognize the pulse rate and rhythm, for selection. It should be noted that token may be display concurrently with decoy tokens so that the customer can select the token from the decoy tokens. In an implantation a token set is meant to denote a set of tokens and decoy tokens comprising a token and a plurality of decoy tokens of the same class that can be presented together to a customer. Tokens may be divided into classes wherein the classes may comprise: a photo class, purchase history class, person's name class, lyrics snippet class, pulse class, or any other currently available grouping of token items into like-classes.

It should be understood that decoy tokens may be retrieved from any available source, and that a decoy token should not been previously selected an input within a merchants computing environment 200.

The method 300 may include the database 204a (or any suitable memory device disposed in communication with the network 208) receiving a customer's username 302 from a customer that the customer would like to use to gain access to the merchant's network. At 303a the username may be stored in memory associated with a customer profile within computing environment 200. The username by the customer may be solicited by a merchant, and may be received over a computer network that both the customer and merchant are connected to. Additionally, the username may be given in person at a retail location of the merchant. Either on-line or in-store, a database 204a (or any suitable memory device disposed in communication with the network 208) used in performing the method 300 may retrieve designated tokens previously stored in memory 303b associated with the username.

At 306 the token retrieved from memory 303b may be placed in a token set with a plurality of decoy tokens and presented to the customer for recognition and selection. The presented token set may be saved in memory 303c for later evaluation and comparison. At 308 a timer is started that monitors the amount of time it takes the customer to recognize and select the token out from the decoy tokens. In an implementation only a small window of time is allowed for a customer to recognize and select the token. For example, five (5) seconds or less may be desirable so that a customer is working from recognition and reflex rather than deduction and reasoning. If too much time is allowed the security of the system and method can be compromised, thus if a customer takes too long to select the familiar token, the system can restart or lock out the customer.

At 310, a customer selection is received and can be stored in memory 303d for later evaluation at 312. The selection may be made by common computer I/O means such as, example I/O device(s) that may include cursor control devices, keyboards, keypads, microphones, monitors or other display devices, speakers, printers, network interface cards, modems, lenses, CCDs or other image capture devices, and the like. The evaluation at 312 may comprise the acts of evaluating the selections made by a customer for correctness and timeliness. At 314, to increase security and avoid a lucky selection by a hacking entity, such as a BOT (or other malware code that repeatedly tries selections), the method 300 may include the database 204a (or any suitable memory device disposed in communication with the network 208) going through additional iterations of processes 306-312.

At 316, the customer may be allowed to sign in to the merchant's network. As can be seen in the present implementation of the disclosure a customer can securely sign in to a merchant network without having to remember or enter a password.

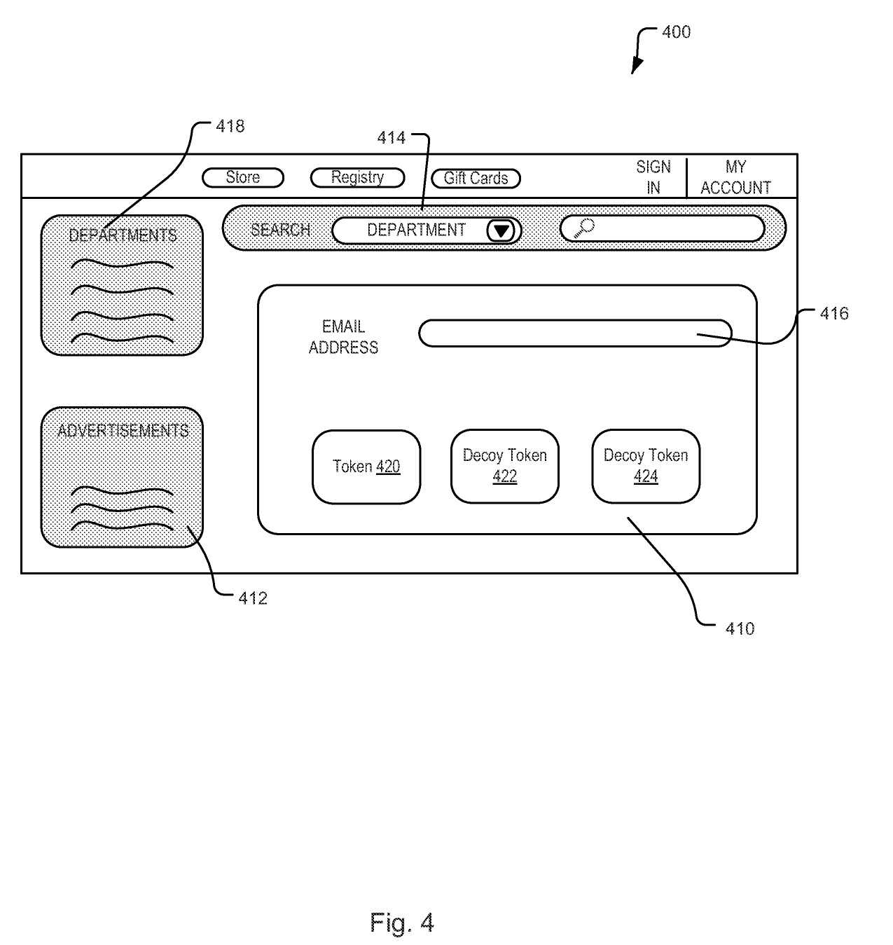

With reference primarily to FIGS. 4, 5 and 6, an implementation of a customer interface having the token recognition functionality and supporting structures will be discussed. FIGS. 1, 2 and 3 may be referenced secondarily during the discussion in order to provide hardware support for the implementation. The disclosure aims to disclose a web page interface that may be encountered by the customer while on-line or within a retail location at a work station within computing environment 200.

As can be seen in the figures, an interface 400 may be in the form of a web interface and displayed within computing environment 200. The interface 400 may comprise a sign-in area 410 that is configured to receive a username in the username input area 416. The interface 400 may also comprise a department navigation area 418 and an advertisement area 412 for aiding customers in navigating a merchant's network. A search area 414 may also be included for a customer's convenience during use. The sign in area 410 may comprise a username input area 416 and a plurality of token and decoy token areas 420, 422 and 424. The interface 400 may operate by method 300 that may include the database 204a (or any suitable memory device disposed in communication with the network 208) receiving a customer's username 302 into the username input area 416 from a customer that the customer would like to use to gain access to the merchant's network. At 303a the username may be stored in memory associated with a customer profile within computing environment 200. The username entered by the customer may be solicited by a merchant, and may be received over a computer network that both the customer and merchant are connected to. Additionally, the username may be given in person at a retail location of the merchant. Either on-line or in-store, a database 204a (or any suitable memory device disposed in communication with the network 208) used in performing the method 300 may retrieve designated tokens previously stored in memory associated with the username.

At 306 the token retrieved from memory 303b may be placed in a token set with a plurality of decoy tokens and presented to the customer for recognition and selection as can be seen in the figure with specific reference to token area 420, decoy token area 422, and decoy token area 424. It should be noted that in an implementation the visual order of the token and decoy token areas may be switched around so that the actual token appears in differing places and orders within the sign in area 410 to aid in the security of the interface. The presented token set may be saved in memory 303c for later evaluation and comparison. At 308 a timer is started that monitors the amount of time it takes the customer to recognize and select the token out from the decoy tokens. In an implementation only a small window of time is allowed for a customer to recognize and select the token. If too much time is allowed the security of the system and method can be compromised, thus if a customer takes too long to select the familiar token, the system can restart or lock out the customer.

Additionally, more or less security may be provided by adding more or less decoy tokens in a token set (three are shown in the figures for illustration and simplicity). For example, a customer may be presented with 9 decoy tokens for every 1 real token within a token set, so that there is only 10% chance of randomly selecting the real token. Furthermore, a second iteration may present another 9 decoy tokens for every 1 real token within a second token set, thereby creating a 1% (10% of 10%) chance of randomly signing. Accordingly, displaying a large number of decoys relative the real token provides greater security, and performing additional iterations serves to compound the increase in security with every iteration. It should also be noted, that the decoy tokens and the real token may be placed randomly on the display relative to each other for added security, so that someone watching a customer sign in would not be able to follow the customer's selection by location on the display in order to defeat the token sets. It is further to be understood that any ratio of decoy tokens to real tokens is within the scope of the present disclosure.

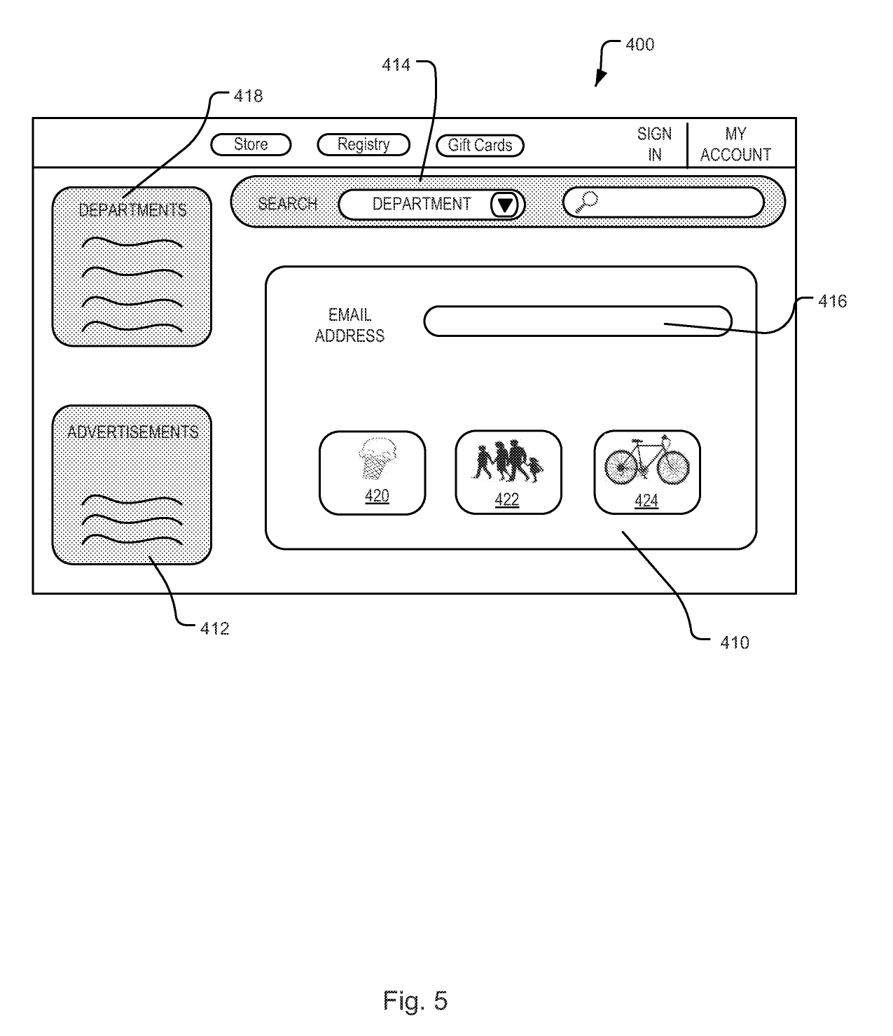

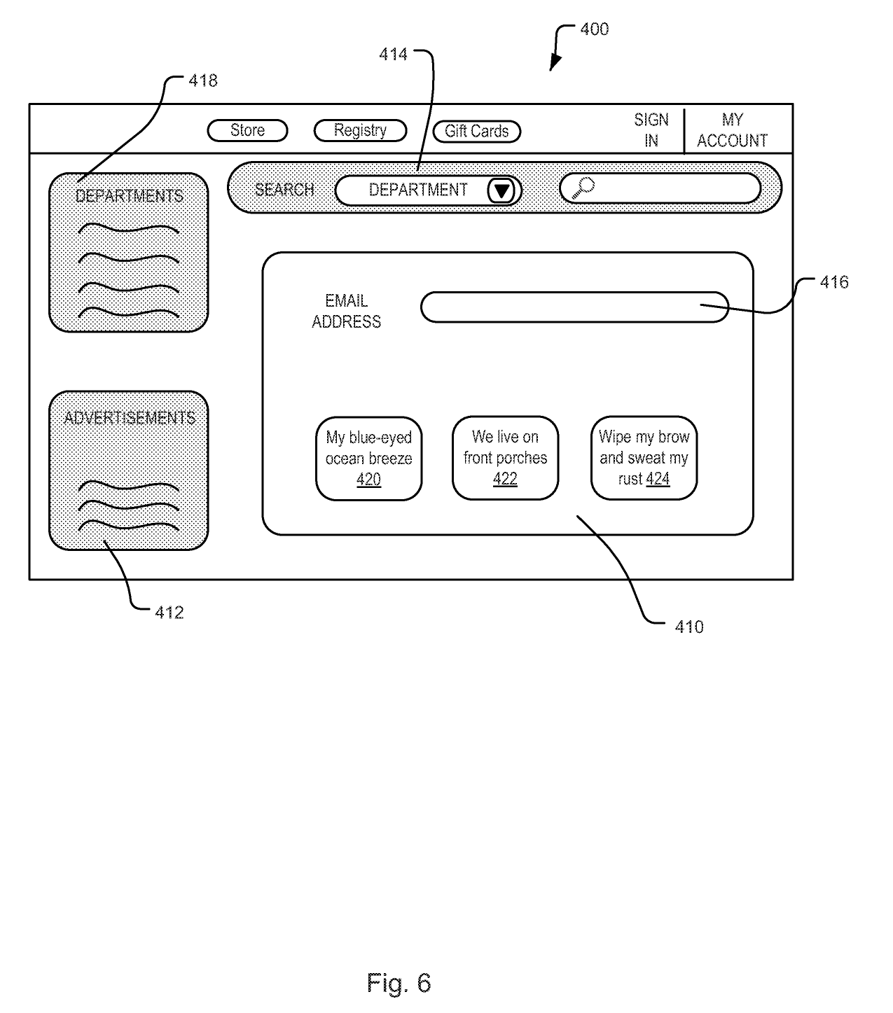

At 310, a customer selection is received and can be stored in memory 303d for later evaluation at 312. During use the customer rapidly selects the token from the decoy tokens for each iteration of the method 300. The selection may be made by common computer I/O means such as, example I/O device(s) that may include cursor control devices, keyboards, keypads, microphones, monitors or other display devices, speakers, printers, network interface cards, modems, lenses, CCDs or other image capture devices, and the like. The evaluation at 312 may comprise the acts of evaluating the selections made by a customer for correctness and timeliness. At 314, to increase security and avoid a lucky selection by a hacking entity, such as a BOT (or other malware code that repeatedly tries selections), the method 300 may include the database 204a (or any suitable memory device disposed in communication with the network 208) going through additional iterations of processes 306-312. In an implementation there may be N number of iterations, where N is an incremental value. For example, in a high risk adverse setting, the customer may be presented with an N^{th} token and N^{th} decoy tokens for selection, where in N is a large number thereby causing the method to run a large number of iterations (as seen in FIGS. 5 and 6). FIGS. 5 and 6 may be viewed as examples of successive iterations (N, and N+1) during a method wherein a customer is signing on to a merchant's network.

As can be seen in FIG. 5, within the sign in area 410, the token and decoy token areas 420, 422 and 424 have been filled with image class tokens. The image used for the token 420 may be retrieved from computer storage or memory that is within computing environment 200 and associated with a file containing attributes of the customer. Customer attributes may have been received previously and input into the system, or selected by a customer, or by receiving attribute information from other sources within the computing environment 200. In an implementation, various documents may be presented by a customer either in person at a retail location, or on-line wherein the attribute information is presented digitally. Furthermore, the attribute information from a customer may be digital in form and may comprise digital copies of such things as: photos, purchase history, song choices, State issued ids, legal documents, images of the customer, utility bills, home address, work history, pay check stubs, car registrations, and/or any other type of attribute. Additionally, a customer at a computer terminal may be able to enter attribute data in order to fill-in fields that represent the selection of attributes to be presented as tokens for recognition. In the figure, a picture of an ice cream cone as token 420, a picture of people waking together as decoy token 422, and a picture of a bike as decoy token 424, are shown in the token selection area. Tokens and decoy tokens may be grouped into classes according to the item type of the token. In the present implementation, the class of token is picture, therefore the class of decoy tokens may also be picture. In an implementation the token and the decoy tokens could be from different classes to add another layer of security.

FIG. 6 illustrates an implementation wherein the tokens and decoy tokens are of a class of fragments of song lyrics. As can be seen in the figure, token area 420 contains the lyric fragment “My blue eyed ocean breeze.” This song may have been selected by the customer to be used as a token, and the lyric portion that is display in 420 may have also been selected by the customer. In an implementation the merchants system may select the lyric portion for presentation based on the customer's selection of the song. The decoy token areas 422 and 424 may display lyric fragments randomly selected by the system to serve as decoy tokens.

As discussed above tokens and decoy tokens can be of like classes, however in other implementations the tokens and decoy tokens can be from different, and the classes of the tokens and decoy tokens can change from iteration to iteration. In an implementation, tokens may be audibly presented in order provide for a blind customer. Additionally, in an implementation the token and decoy token areas may pulse light or color at a recognizable rhythm and cadence that a customer may recognize and select.

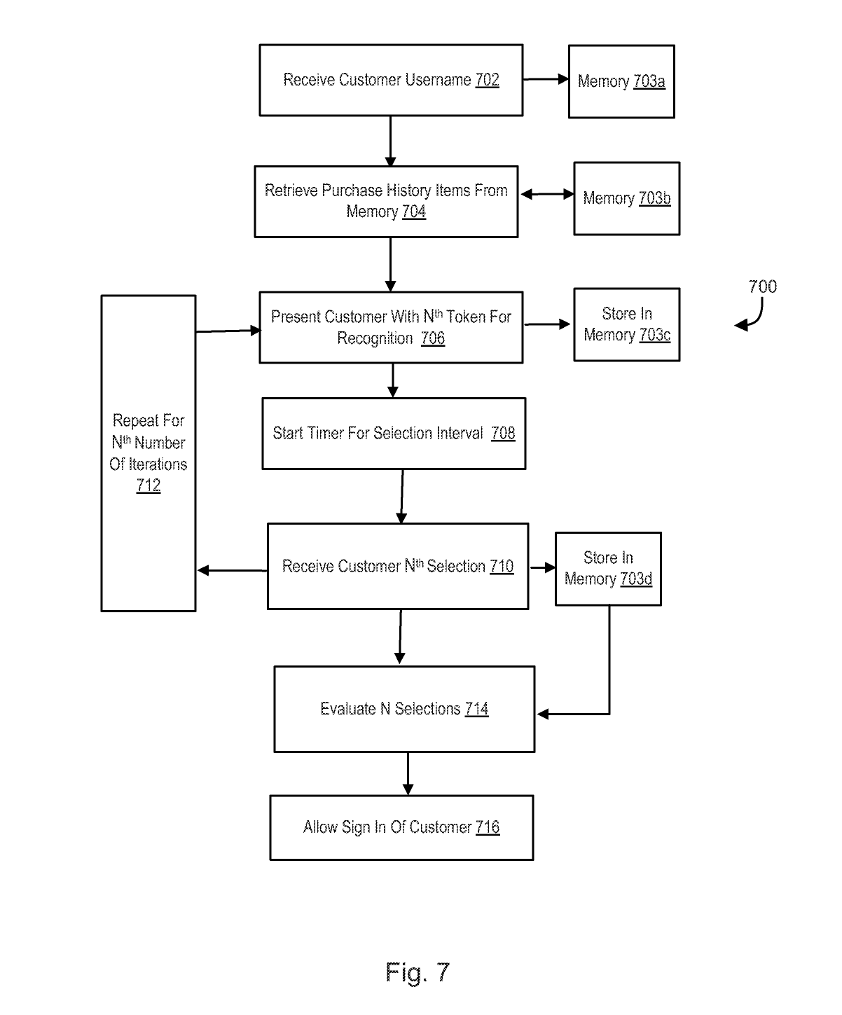

With reference primarily to FIG. 7, an implementation of a method 300 for allowing secure access to a merchant's network through token recognition will be discussed. FIG. 1 and FIG. 2 may be referenced secondarily during the discussion in order to provide hardware support for the implementation. The disclosure aims to disclose methods and systems to allow a customer to designate a plurality of tokens, that when used at a sign in opportunity, can replace the need for the customer to remember a password.

The method 700 may include the database 204a (or any suitable memory device disposed in communication with the network 208) receiving a customer's username 702 from a customer that the customer would like to use to gain access to the merchant's network. At 703a the username may be stored in memory associated with a customer profile within computing environment 200. The username entered by the customer may be solicited by a merchant, and may be received over a computer network that both the customer and merchant are connected to. Additionally, the username may be given in person at a retail location of the merchant. Either on-line or in-store, a database 204a (or any suitable memory device disposed in communication with the network 208) used in performing the method 700 may retrieve designated tokens previously stored in memory associated with the username.

A token, as used herein, is intended to mean any computer output that can be recognized sensorially (sight, hearing, touch and the like) by the customer and then rapidly selected by the customer. For example, in the present implementation, a token may be a picture or description of a previously purchased item from the merchant that is retrieved at 704 from purchase history memory 703b within computing environment 200 and displayed to a customer. It should be noted that token may be displayed concurrently with decoy tokens so that the customer can select the token from the decoy tokens. In an implantation a token set is meant to denote a set comprising a token and decoy tokens of the same class that can be presented together to a customer.

At 706 the token retrieved from the purchase history memory 703b may be placed in a token set with a plurality of decoy tokens, and then presented to the customer for recognition and selection. The presented token set may be saved in memory 703c for later evaluation and comparison. At 708 a timer is started that monitors the amount of time it takes the customer to recognize and select the token out from the decoy tokens by measuring the time between presenting tokens and decoy tokens at 706 and receiving the customer selection at 710. In an implementation only a small window of time is allowed for a customer to recognize and select the token. For example, five (5) seconds or less may be desirable so that a customer is working from recognition and reflex rather than deduction and reasoning. If too much time is allowed the security of the system and method can be compromised, thus if a customer takes too long to select the familiar token, the system can restart or lock out the customer.

At 710, a customer selection is received and can be stored in memory 703d for later evaluation at 714. The selection may be made by common computer I/O means such as, example I/O device(s) that may include cursor control devices, keyboards, keypads, microphones, monitors or other display devices, speakers, printers, network interface cards, modems, lenses, CCDs or other image capture devices, and the like. The evaluation at 714 may comprise the acts of evaluating the selections made by a customer for correctness and timeliness. At 712, to increase security and avoid a lucky selection by a hacking entity, such as a BOT (an automated computer process) or hacker person, the method 700 may include the database 204a (or any suitable memory device disposed in communication with the network 208) going through additional iterations of processes 706-712.

In an implementation there may be n number of iterations desired, where n is an incremental value. For example, in a high risk adverse setting, the customer may be presented with an N^{th} token and N^{th} decoy tokens for selection, wherein n is a large number thereby causing the method to run a large number of iterations. Further the customer may be required to make N^{th} selections to be received at 710 and evaluated at 714.

At 716, the customer may be allowed to sign in to the merchant's network. As can be seen in the present implementation of the disclosure a customer can securely sign in to a merchant network without having to remember or enter a password.

Thus the disclosure provides a method and system for establishing a selection of attributes for conveying customer attributes by considering the nature of the usage by a third party organization. Additionally, the disclosure allows a customer to specify the form of the selection of attributes, the date it is conveyed, and the duration that it is conveyed, before it is shared to a designated third party. The disclosure also provides for the selection of attributes to comprise confidence scores and levels of detail for the attributes therein, and allows attributes of the selection of attributes to be evaluated over time.

The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

Further, although specific implementations of the disclosure have been described and illustrated, the disclosure is not to be limited to the specific forms or arrangements of parts so described and illustrated. The scope of the disclosure is to be defined by the claims appended hereto, any future claims submitted here and in different applications, and their equivalents.

1. A method for providing a customer secured access to a merchant's network, comprising:
receiving a username from the customer;
retrieving from computer memory a first token associated with the customer;
presenting to the customer the first token for recognition and selection by the customer along with a first plurality of decoy tokens;
receiving a first selection by the customer;
monitoring time between presenting the customer with the first token and receiving the first selection;
retrieving from computer memory a second token associated with the customer;
presenting to the customer the second token for recognition and selection by the customer with a second plurality of decoy tokens;
receiving a second selection by the customer;
monitoring time between presenting the customer with the second token and receiving the second selection;
allowing the customer access to the merchant's network if the monitored times are within a predetermined interval and if the first and second tokens are correctly selected.

2. A method according to claim 1, wherein the first token is an image of an item purchased by the customer from the merchant.

3. A method according to claim 1, wherein the first token is an image previously provided by the customer.

4. A method according to claim 1, wherein the first token is a lyric fragment from a song previously provided by the customer.

5. A method according to claim 1, wherein the first token and the second token are pulsed relative to each other at a rate that is recognizable by the customer.

6. A method according to claim 1, wherein the first token is a name of a person known to the customer.

7. A method according to claim 1, wherein the predetermined time interval between presentation of the first token and the first selection by the customer is less than 5 seconds.

8. A method according to claim 1, further comprising:
retrieving from computer memory an n^{th} token associated with the customer;
presenting to the customer the n^{th} token for recognition and selection by the customer along with an n^{th} plurality of decoy tokens;
receiving an n^{th} selection by the customer;
monitoring time between presenting the customer with the n^{th} token and receiving the n^{th} selection.

9. A method according to claim 1, further comprising: denying access if customer selects decoy tokens a number equal to a predetermined number.

10. A method according to claim 1, wherein the decoy tokens are of the same class as the first and second tokens that they are presented with.

11. A system for providing a customer secured access to a merchant's network, comprising: one or more processors and one or more memory devices operably coupled to the one or more processors and storing executable and operational data, the executable and operational data effective to cause the one or more processors to:
receive a username from the customer;
retrieve from computer memory a first token associated with the customer;
present to the customer the first token for recognition and selection by the customer along with a first plurality of decoy tokens;
receive a first selection by the customer;
monitor time between presenting the customer with the first token and receiving the first selection;
retrieve from computer memory a second token associated with the customer;
present to the customer the second token for recognition and selection by the customer with a second plurality of decoy tokens;
receive a second selection by the customer;
monitor time between presenting the customer with the second token and receiving the second selection;
allow the customer access to the merchant's network if the monitored times are within a predetermined interval and if the first and second tokens are correctly selected.

12. A system according to claim 11, wherein the first token is an image of an item purchased by the customer from the merchant.

13. A system according to claim 11, wherein the first token is an image previously provided by the customer.

14. A system according to claim 11, wherein the first token is a lyric fragment from a song previously provided by the customer.

15. A system according to claim 11, wherein the first token and the second token are pulsed relative to each other at a rate that is recognizable by the customer.

16. A system according to claim 11, wherein the first token is a name of a person known to the customer.

17. A system according to claim 11, wherein the predetermined time interval between presentation of the first token and the first selection by the customer is less than 5 seconds.

18. A system according to claim 11, further comprising:
retrieve from computer memory an n^{th} token associated with the customer;
present to the customer the n^{th} token for recognition and selection by the customer along with an n^{th} plurality of decoy tokens;
receive an n^{th} selection by the customer;
monitor time between presenting the customer with the n^{th} token and receiving the n^{th} selection.

19. A system according to claim 11, further comprising: deny access if customer selects decoy tokens a number equal to a predetermined number.

20. A system according to claim 11, wherein the decoy tokens are of the same class as the first and second tokens that they are presented with.
